(19) United States
(12) Patent Application Publication
(10) Pub. No.: US 2009/0001223 A1
(43) Pub. Date: Jan. 1, 2009

(54) Flexible Control Surface for an Aircraft

(75) Inventors: Boris Grohmann, Taufkirchen (DE); Peter Konstanzer, Taufkirchen (DE); Thomas Lorkowski, Taufkirchen (DE)

Correspondence Address: GIBSON & DERNIER L.L.P., 900 ROUTE 9 NORTH, SUITE 504, WOODBRIDGE, NJ, 07095, US

(73) Assignee: Airbus Deutschland GmbH, Hamburg (DE)

(21) Appl. No.: 12/158,405

(22) PCT Filed: Dec. 20, 2006
(86) PCT No.: PCT/EP2006/012288

§ 371 Date: Jul. 10, 2008

(30) Foreign Application Priority Data
Dec. 21, 2005 (DE) 102005061750.6

(51) Int. Cl. B64C 3/48

(52) U.S. Cl. 244/213

(57) ABSTRACT

A flexible control surface (1; 11, 14) comprises at least two actuators (3), which act on the control surface (1; 11, 14) at different points of action (2) which are offset laterally with respect to the circulating-flow direction (6) with respect to one another. The at least two actuators (3) are designed such that the points of action (2) can be deflected differently when the actuators (3) are operated at the same time. It is thus possible to elastically deform the control surface (1; 11, 14), in particular along the span width direction (9), without kinks, in which case it is possible to achieve uniform transitions along the control surface laterally with respect to the flow direction (6). The invention makes it possible to reduce vortices and noise induced by the control surface.

The invention relates to a flexible control surface for an aircraft, and to a method for positioning of a control surface such as this.

An aircraft is provided with control surfaces in order to allow the aircraft to be controlled in flight by individual positioning of the control surfaces. In the case of aircraft, control surfaces such as these are, in particular, flaps which are hinged on the mainplane trailing edge and are used for adaptation to the varying constraints in the course of a flight mission (in particular in the take-off and landing phases). In addition, a control surface for an aircraft may also be an aileron, a rudder or an elevator. The control surfaces may, however, also be leading-edge slats, so-called winglets or nose droops. In the case of helicopters, the controllable rotor blade flaps which are hinged on the rotor blades in the downstream flow are used in particular as control surfaces.

Difficulties can occur in the positioning of stiff control surfaces, with this positioning normally being carried out by means of electrical, hydraulic or electrohydraulic actuators. These include, for example, blocking actuators which prevent positioning of the control surfaces. By way of example, hydraulic actuators may be enabled via bypass valves. In order to keep the effects of blocking actuators small, it is also proposed that the control surfaces be deflected by means of a plurality of actuators, which are each provided with a sliding clutch. This means that a blocking actuator no longer acts actively on the associated control surface, with the control surface then being positioned by the other actuators, which are still functional. An arrangement such as this operates reliably, but its design is complex and, because of the clutches, it is relatively heavy and inefficient from the actuator point of view.

A further problem in the positioning of a control surface results from the fact that discontinuities occur in the flow direction, such as kinks, gaps or slots between the control surface and the body adjacent to it, for example a mainplane. In the same way, on operation of the control surfaces or on extension of flaps, there are gaps between adjacent control surfaces, which are generally arranged alongside one another in the span width direction, and discontinuities in the contour along the span width direction. From the aerodynamic point of view, this means the production of vortices in the air, and noise. These effects become worse when relative movements occur, and the sizes of the associated gaps and slots increase, between the control surfaces and/or between a control surface and the body that is adjacent to it, during flight.

In order to match the curvature of a shell structure, in particular of a mainplane of an aircraft, to different flight states, DE 197 09 917 C1 has proposed that mutually opposite ribs which are arranged in an upper shell and lower shell that form a mainplane be bulged out or drawn together by means of actuators. The shells which are connected to the ribs can in this way be stretched or spherically deformed, so that the mainplane can be provided with a different profile.

An adaptive aircraft mainplane has been proposed in DE 198 58 872 A1, in which rods which are connected to one another in an articulated form are moved by means of an actuator such that a flexible covering on a mainplane can be bulged out or stretched.

However, it is impracticable to deform entire mainplanes or wings since, on the one hand, an adequate load-carrying capacity must be ensured, and on the other hand a fuel tank, which is normally arranged in the mainplanes, must be accommodated.

In the designs proposed in the prior art, the geometry of the mainplane can thus be individually matched to a control surface whose position has been changed, but the gaps and slots between the mainplane and the associated control surface as well as between adjacent control surfaces still remain, so that major vortices still occur in the air.

DE 197 32 953 C1 proposes a mainplane with a flap, which can be bent elastically in the area of the trailing edge by means of an actuator which is arranged outside the profile of the flap. For this purpose, the flap is produced with a covering skin on the suction side and pressure side composed of elastic material. A design such as this makes it possible to elastically deform an entire flap upwards or downwards, with the transition to the adjacent body in the circulating-flow direction having no kinks.

Instead of this, the elastic material results in a continuous transition, thus reducing vortices. Considerable wake vortices are still evident, even with systems such as these.

The object of the present invention is therefore to provide an apparatus and a method by means of which the production of vortices in the air caused by control surfaces can be reduced in order in this way to reduce induced noise and induced wake vortices.

This object is achieved by an apparatus and a method having the features of the independent claims. Advantageous refinements of the invention are specified in claims which are dependent on these.

The flexible control surface according to the invention comprises at least two actuators which act on the control surface at different points which are arranged offset with respect to one another and laterally with respect to the flow direction, that is to say in the span width direction (“points of action”) and are designed to deflect these points of action differently when the actuators are operated at the same time. In this context, “flexible” means that at least the shape and/or the area extent of the surface of the control surface is variable, with the control surface having a continuous form (that is to say, in particular, there are no gaps or slots in the control surface). For example, at least in places, the control surface may have a sinusoidal extent, or some other wave-like flat extent. The different deflection of the points of action makes it possible for the control surface to be deformed elastically without kinks, in particular in the span width direction, with uniform transitions being achieved, for example, to an adjacent body (for example the mainplane) along the control surface in the span width direction. In particular, despite fundamentally different positioning, the mutually adjacent areas of mutually adjacent control surfaces can be deflected so that a continuous transition results at a gap. This makes it possible to reduce vortices and noise which are induced by the control surfaces and gaps which were previously present.

Furthermore, when an actuator is blocked, the control surface according to the invention can still be deflected at least partially by virtue of its flexibility by means of the remaining actuators, since the control surface is blocked only at the point of action of the blocked actuator. The effectiveness of the control surface is thus largely retained when an actuator is blocked, and is not rendered completely ineffective, as in the case of apparatuses according to the prior art. Clutches for freeing a blocked actuator are not required, so that the increase in mass associated with this, the design complexity and the control complexity are low in comparison to conventional apparatuses.

The points of action can preferably be deflected such that the control surface can be flexibly deformed in bending, torsion and curvature. This allows the aerodynamic effectiveness (for example in terms of lift, drag or pitch moment) induced by the control surface to be set specifically. In particular, the control surface can be bent or warped in the span width direction, that is to say laterally with respect to the circulating-flow direction, and/or the trailing edge of the control surface can be curved in or against the flow direction. In other words, the control surface advantageously has a corrugated (for example similar to a sinusoid) area extent in the span width direction. In the case of an aircraft mainplane, this can be used to influence the desired lift distribution and a span-wide load distribution during takeoff, cruise flight and during landing of the aircraft. It is thus particularly advantageous to have the capability for the actuators to be deflected individually by an individual drive. Ideal conditions can thus be set for any situation.

The control surface according to the invention is typically a flap, which is articulated on the mainplane trailing edge, of an aircraft, but may also be a rudder, an aileron, an elevator or a trimming tab on a aircraft. The control surface, may, of course, also be a leading-edge slat, so-called winglets or nose droops, and may be provided at points at which no control surfaces are provided at the moment, but at which the aim is to achieve aerodynamic effects specifically, or to control them.

The flaps are required for the take-off and landing phase. The rudder is used to turn an aircraft about the vertical axis, while an aileron on the trailing end of a mainplane allows the aircraft to be moved about the longitudinal axis. An elevator is used to incline an aircraft about the lateral axis, so that the longitudinal pitch and the pitch angle of the aircraft are changed. A trimming tab at the tail of an aircraft is used for pitch trimming. The control surface according to the invention thus makes it possible to set the drag and flow profile induced by the control surface at any position of an aircraft during flight. In principle and in addition, aerodynamic control surfaces which are not used for primary control of the aircraft are, of course, also considered.

According to the invention, the control surface may also be a component of a rotor blade. A rotor blade is used, for example, for a horizontally arranged rotor on a helicopter. Rotor blades on a helicopter act like rotating mainplanes on a fixed-wing aircraft, so that in principle the same advantages, as mentioned above, apply as in the case of a fixed-wing aircraft. In this case, the control surface may also be a controllable rotor blade flap which is articulated in the downstream flow on the rotor blade.

A rotor blade as well as a flap which may be articulated on it can also be used in a wind energy installation with a vertically arranged rotor in order to achieve a desired drag and to develop less noise.

It is advantageous for the control surface to be formed from a fibre-composite material. A material such as this generally has a plastic matrix and reinforcing fibres, incorporated in it, as main components. The elasticity and strength of a material such as this can be set as desired by suitable choice of material and/or fibre orientation for specific load directions, so that bending, torsion or curvature of the control surface can be influenced specifically, although on the other hand the required strength is ensured.

The invention also relates to a corresponding method for deflection of the points of action of the control surface described above, in which the points of action are deflected differently by the actuators when the at least two actuators are operated at the same time. This makes it possible to specifically influence the drag induced by the control surface and the corresponding flow profile.

According to one alternative embodiment, the points of action of two adjacent control surfaces are deflected by the actuators such that at least one end of the mutually adjacent ends of the control surfaces is curved towards the respective other end of the two ends. This results in a quasi-continuous transition, thus resulting in reduced vortices and less noise being created by the control surfaces. This also has an advantageous effect on wake vortices, since they are dissipated quickly. This allows aircraft to follow one another more closely, thus allowing a greater air-traffic density. A quasi-continuous transition can likewise be produced analogously, for example, between a side end of the control surface and a generally rigid connecting area, on which the control surface is mounted.

Further features and advantages of the invention will become evident from the following description in conjunction with the attached drawings, in which:

FIG. 1 shows a perspective schematic illustration of a control surface according to the invention, with actuators;

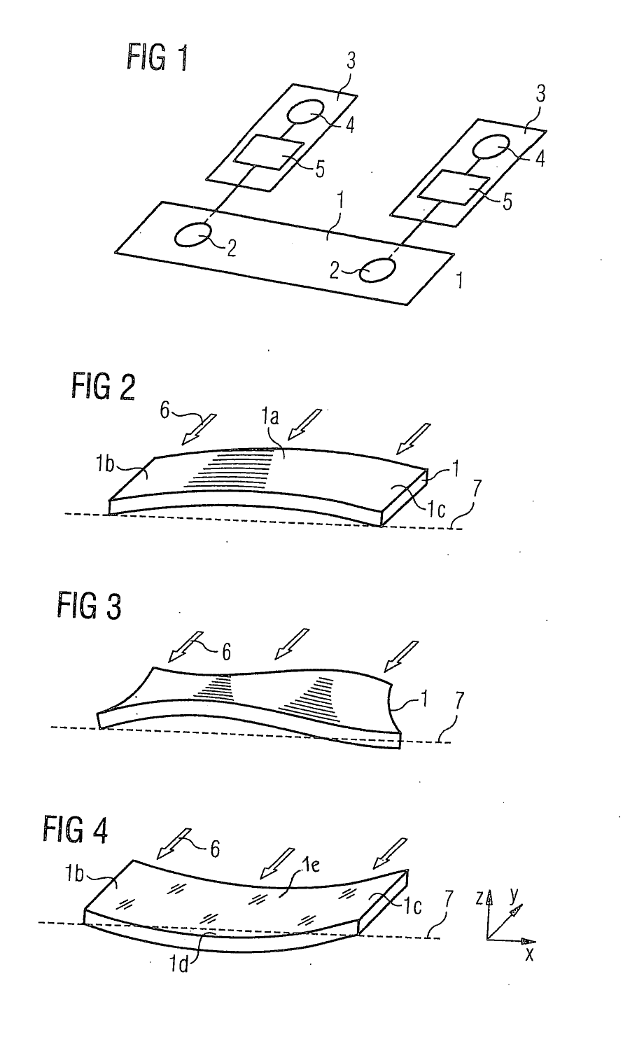

FIG. 2 shows a perspective view of a control surface bent laterally with respect to the flow direction;

FIG. 3 shows a perspective view of a control surface warped laterally with respect to the flow direction;

FIG. 4 shows a perspective view of a control surface which has been curved forwards in the flow direction;

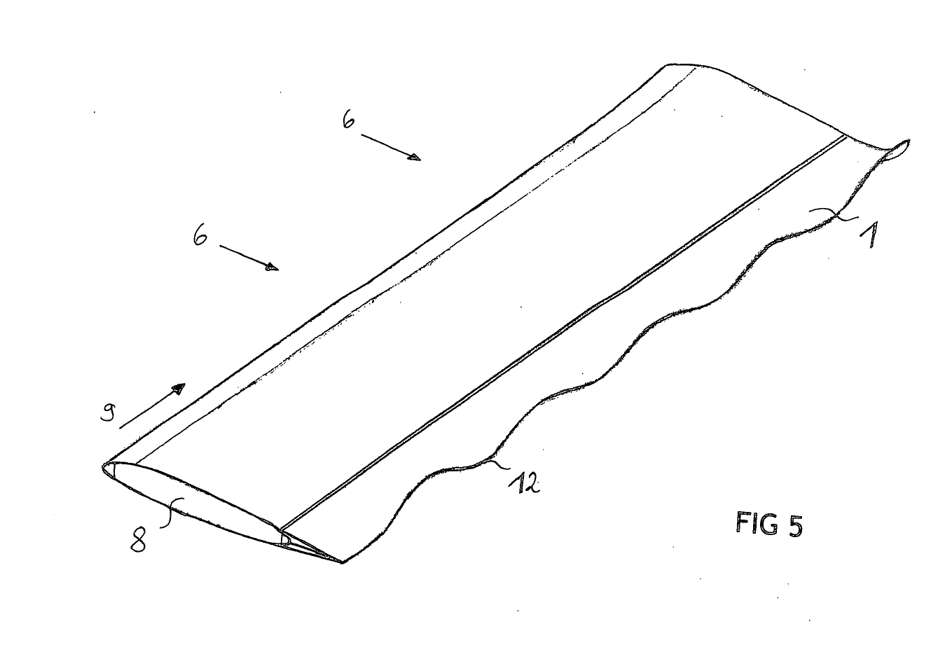

FIG. 5 shows a perspective view of an aerodynamic profile, in particular of a mainplane, with a control surface according to the invention;

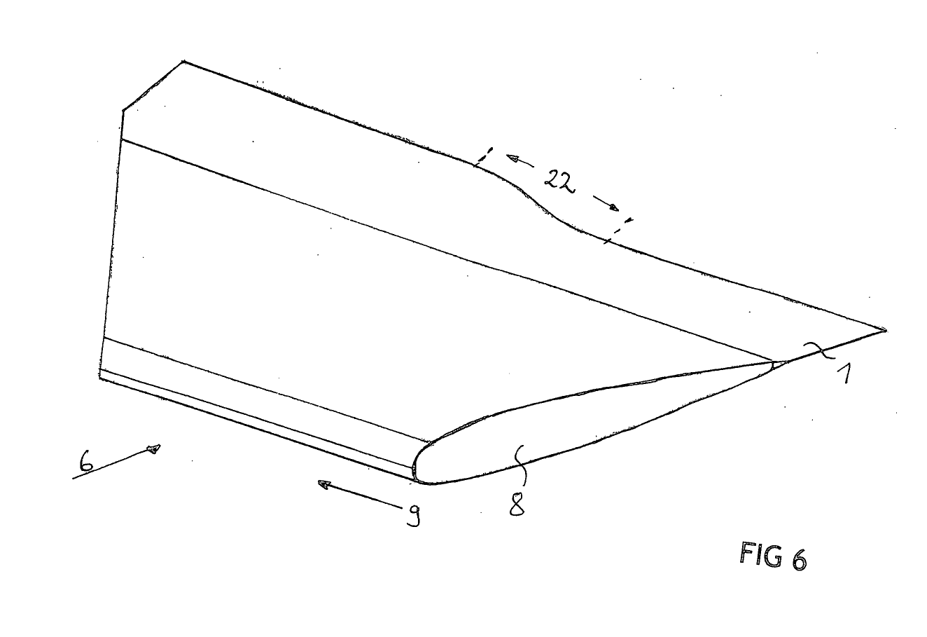

FIG. 6 shows a perspective view of a further aerodynamic profile, in particular of a mainplane, with a control surface according to the invention;

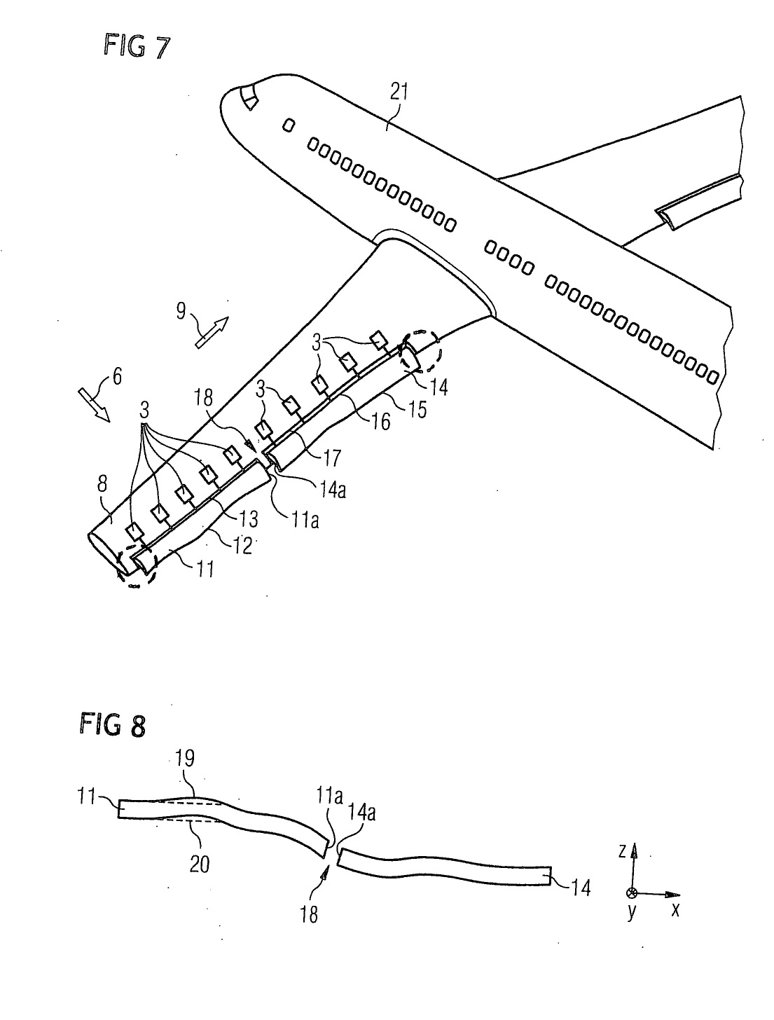

FIG. 7 shows a perspective view of a mainplane of an aircraft with two control surfaces according to the invention, and

FIG. 8 shows a front view of two control surfaces deflected according to the invention.

FIG. 1 shows a perspective schematic illustration of a flexible control surface 1. The control surface 1 has two points of action 2, on each of which an actuator 3 acts. An actuator 3 such as this generally comprises a motor 4 and, for example, a linear or rotary transmission 5. The motor may be in the form of force and movement generators, such as electric motors, piezo-ceramics, pneumatic or hydraulic arrangements or the like. The actuators 3 may be operated in such a way that, when the actuators 3 are operated at the same time, the points of action 2 can be deflected differently by the actuators 3. A control surface 1 can thus be elastically deformed, for example upwards or downwards, either at both points of action or only at one point of action.

FIGS. 2 to 4 show a number of possible deformation states of the control surface, which can also be used in any desired combination with one another. FIG. 2 shows a control surface 1 which is bent about an axis parallel to the flow direction 6. The geometric centre 1a of the control surface 1 is raised above the left-hand end 1b and right-hand end 1c, which can be connected to one another by a horizontal line 7, which is shown as a dashed line.

The control surface 1 can also be deformed via the points of action 2 in such a way that a torsion load is exerted on the control surface (see FIG. 3). The torsion axis in the case of the control surface 1 shown in FIG. 3 lies laterally with respect to the flow direction 6. However, it may also be placed on any desired axis if this is advantageous in order to achieve a desired flow effect (for example lift, drag, pitch moment) and/or minor flow vortices.

In addition, the control surface 1 can be curved such that the central area 1d of the trailing edge 1d is located in front of the side ends 1b and 1c in the flow direction 6 (see FIG. 4). The opposite edge 1e in the illustrated exemplary embodiment is curved approximately to the same extent as the trailing edge 1d in the flow direction. However, it can also be firmly clamped in, in order to prevent gap formation.

Deformations of the control surface 1 such as these with respect to bending, torsion and/or curvature are dependent on a relatively high degree of elasticity in predetermined axes with high strength at the same time, and this can be achieved, for example, by the control surface being produced from a fibre-composite material.

FIGS. 5 and 6 show further possible deformation states of the control surface according to the invention. FIG. 5 shows an aerodynamic profile 8, for example a mainplane or a rotor blade, on which a flexible control surface 1 is arranged in the downstream flow, that is to say at the profile trailing edge. In FIG. 5, the flow direction is once again annotated with the reference symbol 6, and the span-width direction by the reference symbol 9. The actuators which deform and/or deflect the flexible control surface 1 are not shown, for the sake of clarity. The flexible control surface 1 can be deformed in bending, torsion and/or curvature, as described in conjunction with FIGS. 2 to 4, with the control surface 1 having a continuous flat extent at all times, that is to say not having any gaps, slots or slits. In the exemplary embodiment illustrated in FIG. 5, the trailing edge 12 of the control surface 1 has a continuous corrugated shape.

FIG. 6 shows a partial detail of a further option for deformation of a flexible control surface 1 which is arranged on an aerodynamic profile 8, in particular a mainplane or a rotary blade, at its trailing edge in the downstream flow. As in FIG. 5, the actuators which deflect the control surface 1, are not illustrated, for the sake of clarity. The flow direction is once again annotated with the reference number 6, and the span-width direction with the reference number 9. The flexible control surface 1 illustrated in FIG. 6 is not deflected to the right of the transitional area 22, but merges in the transitional area 22 in a corrugated shape into a deflected area (area to the left of the transitional area 22).

FIG. 7 shows a perspective view of a mainplane 8 of an aircraft 21. A plurality of actuators 3 are arranged alongside one another in the span-width direction 9 of the mainplane 8. In this embodiment, five actuators 3 act on a first control surface 11 with a trailing edge 12 and a leading edge 13. In this embodiment, the actuators are operated such that the flexible first control surface 11 is deformed in such a manner that good span-width lift distribution and load distribution are achieved by means of a smooth contour without any kinks, gaps or edges, for various flight phases such as take-off, cruise flight or landing. For example, the first control surface 11 in the position illustrated in FIG. 7 is bent and warped in the span-width direction.

In the arrangement shown in FIG. 7, a second control surface 14 with a trailing edge 15 and a leading edge 16 is provided adjacent to the first control surface 11, with five actuators 3, which are arranged alongside one another across the span, likewise acting on this second control surface 14. The points of action on the second control surface 14 may, for example, be deflected so as to minimize a gap 17 between the mainplane 8 and the second control surface 14. In this case, the second control surface 14 is curved in the flow direction 6 for this purpose. The control surfaces 11 and 14 may have any desired continuous area extent, in a corrugated shape in the span-width direction.

There is gap 18 in the span-width direction between the first control surface 11 and the second control surface 14, as shown in FIGS. 7 and 8. In order to keep the effects of this gap, in terms of drag, vortex formation and noise induced in consequence as low as possible, points of action on the two control surfaces 11 and 14 which are adjacent to one another can be deflected by the actuators such that at least one end 11a or 14a of the mutually adjacent ends 11a, 14a of the respective control surfaces 11, 14 is or are curved towards the respective other end 14a or 11a of the two ends, thus effectively resulting in a continuous transition. In the case of the control surfaces 11 and 14 illustrated in FIG. 8, the two ends 11a, 14a can be connected to one another by a virtual straight line so as to produce a continuous transition between the two control surfaces, as a consequence of which only minor vortices are induced in the air. Quasi-continuous transitions such as these may, of course, also be produced in an analogous manner between one end of the control surface and an adjacent rigid connecting area which, for example, is integrated in the mainplane 8 (see the areas marked with dashed circles in FIG. 7); this means that, for example in FIG. 8, the control surface 14 could also be replaced by a rigid connecting area.

FIG. 8 also shows an undesirable deflection 19 of the first control surface 11 which has been created, for example, as a result of a blocked actuator. The desired deflection 20 instead of this of the first control surface 11 is represented by a dashed line. A comparison between the deflection 20 and the deflection 19 shows that there is a discrepancy from the desired profile. However, because of the elastic flexibility of the first control surface 11, the deflection 19 leads only to a minor change in the contour of the first control surface 11, so that the majority of the effectiveness of the first control surface 11, in terms of low vortex formation and noise, is still provided.

In principle, there are no restrictions to the numbers of actuators for each control surface, so that very finely graduated deformation of the control surface is possible not only in the span-width direction but also in the flow direction.

In the arrangement shown in FIG. 7, instead of the two control surfaces 11 and 14, a single control surface (as is shown by way of example in FIG. 5 or FIG. 6) can also be used, which essentially extends over the entire span width of the mainplane 8 (for example from the left-hand area marked with a dashed circle to the right-hand area marked with a dashed circle). In this case, the deformation can take place quasi-continuously at the transition from one side end of the control surface to the connecting area, as described in conjunction with FIG. 8.

The flexible control surfaces 1, 11 and 14 as described above make it possible to avoid gaps, kinks or discontinuities at the transitions from the control surface to the respective rigid connecting areas—both in the span-width direction and in the flow direction.

1. A flexible control surface for an aircraft, comprising at least two actuators which act on the control surface at different points of action such that the points of action are arranged next to one another in the span width direction of the control surface, wherein the control surface has essentially a flat area extent in span width and flow direction and is elastic flexible; and the at least two actuators are designed to deflect the points of action differently when the actuators are operated at the same time, such as to elastically deform the control surface in span width and flow direction.

2. The flexible control surface according to claim 1, wherein the elastically deformed control surface has a continuous, kink-free form.

3. The flexible control surface according to claim 1, wherein the elastically deformed control surface has a uniform transition along the control surface in span width direction to an adjacent body.

4. The flexible control surface according to claim 1, wherein the side ends of the elastically deformed control surface form a quasi-continuous transition to an adjacent connecting area.

5. The flexible control surface according to claim 1, wherein the actuators are driven individually.

6. The flexible control surface according to claim 1, wherein the points of action are deflected such that the control surface is flexibly bent, warped and/or curved.

7. The flexible control surface according to claim 6, wherein the points of action are deflected such that the control surface is flexibly bent and/or warped in span width direction.

8. The flexible control surface according to claim 6, wherein the points of action are deflected to flexibly curve the control surface such that its trailing edge is located in front of or behind the side ends of the control surface in flow direction.

9. The flexible control surface according to claim 1, wherein the elastically deformed control surface has at least partially a corrugated, preferably sinusoidal, area extent in span width direction.

10. The flexible control surface according to claim 1, wherein the control surface is a flap, a rudder, an aileron, an elevator or a trimming tab.

11. The flexible control surface according to claim 1, wherein the control surface is a component of an aerodynamic profile, in particular of an aircraft wing.

12. The flexible control surface according to claim 1, wherein the control surface is a component of a rotor blade, in particular of a rotor blade flap.

13. The flexible control surface according to claim 1, wherein the control surface is formed from a fibre-composite material.

14. A method, comprising:
positioning a control surface of an aircraft, wherein:
the control surface comprises: at least two actuators which act on the control surface at different points of action such that the points of action are arranged next to one another in the span width direction of the control surface,
the control surface has essentially a flat area extent in span width and flow direction and is elastic flexible; and
the at least two actuators are designed to deflect the points of action differently when the actuators are operated at the same time, such as to elastically deform the control surface in span width and flow direction.

15. The method according to claim 14, wherein the points of action are deflected such that the control surface is flexibly bent, warped and/or curved.

16. The method according to claim 15, wherein the points of action are deflected such that the control surface is flexibly bent and/or warped in span width direction.

17. The method according to claim 15, wherein the points of action are deflected to flexibly curve the control surface such that its trailing edge is located in front of or behind the side ends of the control surface in flow direction.

18. The method according to claim 14, wherein the points of action of two adjacent control surfaces are deflected by the actuators such that at least one end of the mutually adjacent ends of the control surfaces is curved towards the respective other end of the two ends.

19. An aerodynamic profile, comprising:
at least one control surface comprising at least two actuators which act on the control surface at different points of action such that the points of action are arranged next to one another in the span width direction of the control surface, wherein
the control surface has essentially a flat area extent in span width and flow direction and is elastic flexible;
the at least two actuators are designed to deflect the points of action differently when the actuators are operated at the same time, such as to elastically deform the control surface in span width and flow direction,
the at least one control surface is arranged at the trailing edge of the aerodynamic profile,
the elastically deformed control surface has at least partially a continuous corrugated shape in sputa width direction, and
the elastically deformed control surface has a quasi-continuous transition to adjacent control surfaces, adjacent connecting areas and/or adjacent gaps.
